(19) United States
(12) Patent Application Publication
(10) Pub. No.: US 2023/0393294 A1
(43) Pub. Date: Dec. 7, 2023

(54) METHOD OF UPDATING A VELOCITY MODEL OF SEISMIC WAVES IN AN EARTH FORMATION

(71) Applicant: SHELL USA, INC., HOUSTON, TX (US)

(72) Inventors: Pandu Ranga Rao DEVARAKOTA, Houston, TX (US); John Jason KIMBRO, Houston, TX (US)

(21) Appl. No.: 18/250,213

(22) PCT Filed: Nov. 16, 2021
(86) PCT No.: PCT/EP2021/081824

§ 371 Date: Apr. 23, 2023

Related U.S. Application Data
(60) Provisional application No. 63/117,257, filed on Nov. 23, 2020.

(51) Int. Cl. G01V 1/28; G01V 1/30; G06N 3/0464; G06N 3/08

(52) U.S. Cl. CPC G01V 1/282; G01V 1/303; G06N 3/0464; G06N 3/08; G01V 2210/514

(57) ABSTRACT

A method involving automated salt body boundary interpretation employs multiple sequential supervised machine learning models which have been trained using training data. The training data may consist of pairs of seismic data and labels as determined by human interpretation. The machine learning models are deep learning models, and each of the deep learning models is aimed to address a specific challenge in the salt body boundary detection. The proposed approach consists of application of an ensemble of deep learning models applied sequentially, wherein each model is trained to address a specific challenge. In one example an initial salt boundary inference as generated by a first trained first deep learning model is subject to a trained refinement deep learning model for false positives removal.

### FIELD OF THE INVENTION

The present invention relates to a computer-implemented method of updating a velocity model of seismic waves in an Earth formation. The present invention further relates to a computer system configured to execute this method.

### BACKGROUND TO THE INVENTION

There is a strong interest in developing machine learning methods to on one hand reduce time needed for interpretation of seismic data obtained for Earth formations, and on the other hand to enhance accuracy and objectivity where possible.

WO 2020/009850 A1 describes a workflow involving cascaded machine learning for salt seismic interpretation. First, a trained machine learning model is used to generate a probability cube of top of salt (and/or bottom of salt) labels based on combined predictions on entire seismic cubes in inline direction and in crossline direction. A threshold is then applied on the probability cube, to generate a binary cube where, for example, 1=salt and 0=no salt. The workflow further comprises steps wherein recursions are made to update training data. This requires some level human intervention for each seismic cube that is to be processed.

### SUMMARY OF THE INVENTION

In one aspect, there is provided a computer-implemented method of updating a velocity model of seismic waves in an Earth formation, comprising:
a) providing a migrated seismic data volume obtained by at least migrating a post stack seismic data volume using an initial velocity model;
b) determining a probability, for each point in the migrated seismic data volume, of including a signal corresponding to a reflection from a salt body boundary, comprising applying a trained first deep learning model to make said determination;
c) generating a first salt body boundary probability volume based on the probabilities as determined by the first deep learning model,
d) refining the probabilities in each point of the first salt body boundary probability volume by applying a trained refinement deep learning model, which selectively replaces probabilities with replacement probabilities of higher or lower values, to thereby generate a refined continuous salt body boundary identification;
e) generating a refined salt body boundary probability volume based on the refined continuous salt body boundary identification;
f) converting the refined salt body boundary probability volume to a binary salt body boundary interpreted volume; and
g) generating an updated velocity model by updating the initial velocity model using a salt body estimation which matches the binary salt body boundary interpreted volume.

In another aspect, there is provided a computer system comprising:
at least one processor;
a memory system comprising non-transitory computer-readable non-transient memory on which are stored computer-readable instructions that, when executed by said at least one processor, cause the computer system to:
   a) access a migrated seismic data volume obtained by at least migrating a post stack seismic data volume using an initial velocity model;
   b) determine a probability, for each point in the migrated seismic data volume, of including a signal corresponding to a reflection from a salt body boundary, comprising applying a trained first deep learning model to make said determination;
   c) generate a first salt body boundary probability volume based on the probabilities as determined by the first deep learning model,
   d) refine the probabilities in each point of the first salt body boundary probability volume by applying a trained refinement deep learning model, which selectively replaces probabilities with replacement probabilities of higher or lower values, to thereby generate a refined continuous salt body boundary identification;
   e) generate a refined salt body boundary probability volume based on the refined continuous salt body boundary identification;
   f) convert the refined salt body boundary probability volume to a binary salt body boundary interpreted volume; and
   g) generate an updated velocity model by updating the initial velocity model using a salt body estimation which matches the binary salt body boundary interpreted volume.

Optionally, non-transitory computer-readable non-transient memory of the computer system may contain further computer-readable instructions capable of causing the computer system to execute one or more other processing steps as set forth herein, including those specified in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 schematically shows a block diagram of a general implementation of the proposed method;

FIG. 2a shows an example data slice of migrated data volume (data courtesy of TGS);

FIG. 2b shows a ground truth of a top of salt body boundary for the data slide of FIG. 2a;

FIG. 3a shows an example of a raw salt body boundary inference;

FIG. 3b shows an example of a human interpreted ground truth;

FIG. 4a shows an example data slice of migrated data volume (data courtesy of CGG);

FIG. 4b shows an example of a raw salt body boundary inference of the data slice of FIG. 4a;

FIG. 4c shows an example of a refined salt body boundary inference;

FIG. 5a shows another example data slice of migrated data volume (data courtesy of CGG);

FIG. 5b shows an example of a raw salt body boundary inference of the data slice of FIG. 5a;

FIG. 5c shows an example of a refined salt body boundary inference; and

FIG. 6 schematically shows a block diagram of an example how the proposed method may be applied in a top of salt interpretation workflow.

### DETAILED DESCRIPTION OF THE INVENTION

The person skilled in the art will readily understand that, while the detailed description of the invention will be illustrated making reference to one or more embodiments, each having specific combinations of features and measures, many of those features and measures can be equally or similarly applied independently in other embodiments or combinations.

We introduce a novel method involving automated salt body boundary interpretation, which employs multiple sequential supervised machine learning models which have been trained using training data. The training data may consist of pairs of seismic data and labels as determined by human interpretation which seismic data does not comprise any elements from the migrated seismic data volume which is subject to the inference using the multiple sequential supervised machine learning models. In other words, the method can be applied to any migrated seismic data volume, and no part of the data volume is needed for (additional) training.

The machine learning models are deep learning models, and each of the deep learning models is aimed to address a specific challenge in the salt body boundary detection. It has been found that this sequential approach of multiple deep learning models is more robust and reliable than what is possible using a single model. The invention may in part be based on an insight gained by the inventors, after extensive experimentation and validation on many real datasets, that one universal model solving the challenges will not be feasible. The proposed approach thus consists of application of an ensemble of deep learning models applied sequentially, wherein each model is trained to address a specific challenge. The approach also helps to meet rigorous practical requirements of the model building process.

The various deep learning models employed in the proposed method may consist of deep convolutional neural networks (CNN). A wide variety of architectures may be employed, including for example U-Net (O. Ronneberger, P. Fischer, T. Brox, “U-Net: Convolutional networks for biomedical image segmentation,” Medical Image Computing and Computer Assisted Intervention, Springer, 2015, pp. 234-241) and ResNet (K. He, X. Zhang, S. Ren and J. Sun, “Deep Residual Learning for Image Recognition,” IEEE Conference on Computer Vision and Pattern Recognition (CVPR), Las Vegas, NV, 2016, pp. 770-778).

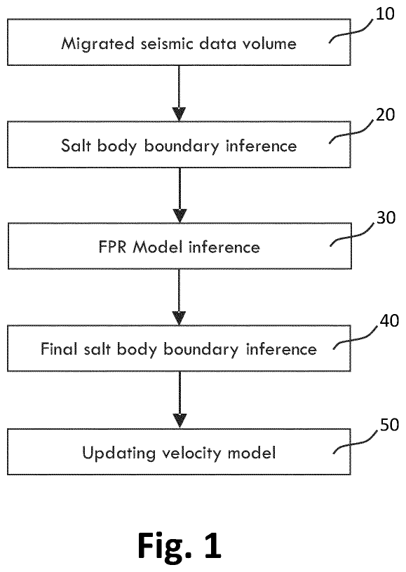

Reference is now made to FIG. 1, to illustrate a general implementation of the proposed method. A migrated seismic data volume is provided 10 as input to the method. Any known migration techniques like Kirchhoff depth migration or Reverse Time Migration can be used to for this purpose. The seismic data is suitably rescaled, such that the range of seismic amplitude values is the same for all data sets. The seismic amplitudes values may for example be mapped within a range of from −1 to +1. This rescaling helps to minimize the data variation between various surveys and to bring them to a common scale for comparison.

The migrated seismic data volume has been obtained by migrating a post stack seismic data volume using an initial velocity model. The initial velocity model may, for example, take into account only sediment velocities and no salt body velocities. The method is designed to estimate a salt body, and the interpreted data volume can be used to update the velocity model which was initially used to migrate the seismic data by including salt body velocity.

The salt body estimation comprises at least two sequential trained deep learning models. The first step is referred to as a raw salt body boundary inference 20 and uses a trained first deep learning model. The migrated seismic data volume is input to the trained first deep learning model. The trained first deep learning model determines a probability, for each point in the migrated seismic data volume, that the signal includes a signal corresponding to a reflection from a salt body boundary. Thus, for each point in this volume, the model generates the probability of being associated with a salt body boundary reflection. The size of the inference output is same as the input data volume.

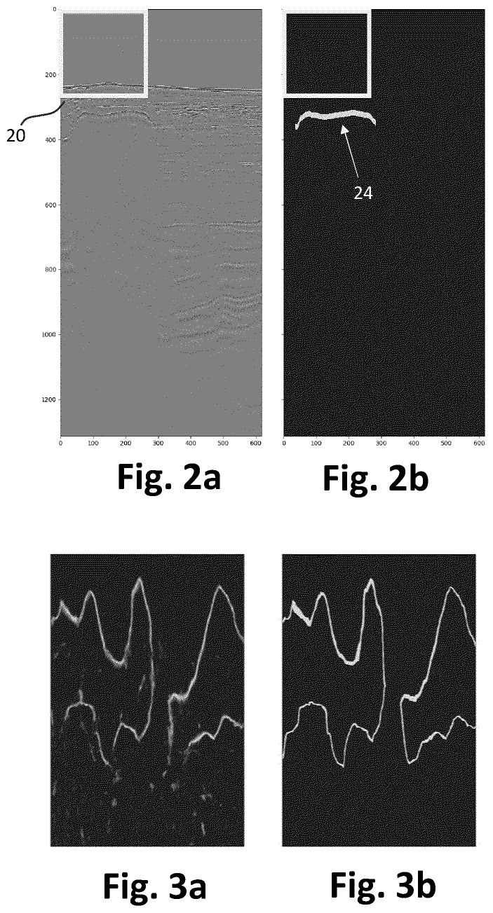

The training strategy is illustrated in FIG. 2. The first deep learning model is trained predominantly in two dimensions (2D), in which the deep learning network is trained on a large training dataset of pairs of 2D tiles 22, of predetermined size. The pairs of 2D tiles comprise seismic data and corresponding ground truth labels which are positive at salt body boundaries and negative where there is no salt body boundary as determined by human interpretation. Multiple tiles at different coordinates within each slice are employed. Tiles may (partly) overlap other tiles. The training data set is preferably extracted from volumes of various surveys. The pairs consist of seismic signals (FIG. 2a) and human interpreted labels (FIG. 2b). The light shaded area 24 in FIG. 2b for example represent positive labels indicating a human interpreted location of a top of salt (TOS) boundary 24.

Positive labels may be “flooded” to make them thicker. By this it is meant that the ground truth positive labels are applied to a predetermined number of surrounding pixels in said 2D tiles around the pixels that are human-interpreted to correspond to a salt body boundary. This alleviates incorrect and imprecise labels, and it allows some surrounding “context” around the salt body boundary pixels to be taken into account by the deep learning model. It was found that the models trained on these thick labels were more robust and efficient in handling errors in labeling process (act as implicit regularization) as well as generating a wide range of probabilities in the areas of ambiguity in the image.

Back to FIG. 1, during the inference stage of raw salt body boundary inference 20, the model is applied on both crossline and inline slices of the data volume. Probabilities are subsequently combined to generate one probability volume. This may be done by taking average values or picking the higher of the two values found in the crossline and inline slices. In order to reduce the artifacts (noise) at the tile boundaries, the inference is generated on a large cross section of the image, possibly the largest possible cross section that can fit into computer processing memory.

The trained first deep learning model ultimately generates a first salt body boundary probability volume, based on the probabilities as determined by the first deep learning model. This may also be referred to as a raw salt body boundary probability volume. FIG. 3a shows an example of what that may look like. It can be seen that the raw salt body boundary probability volume tends to contain false positives indicating relatively high salt body boundary probabilities where there is in fact no salt body boundary, as well as false negatives which manifest itself as unlikely interruptions in a nominally continuous salt body boundary.

The proposed method therefore comprises a refinement deep learning model trained to establish a refinement inference 30, which may also be referred to herein as false positive removal (FPR) inference 30 although in practical effect the model may also correct false negatives by attributing a higher probability value to certain points in the probability volume. Probabilities in each point of the first salt body boundary probability volume that was generated in the salt body boundary inference 20, is selectively replaced with a lower value or a higher value based on training data which reinforce typical appearance of continuous salt body boundaries, by applying a trained refinement deep learning model, which selectively replaces probabilities in points with replacement probabilities having a lower value. Thereby a refined and more continuous salt body boundary identification is generated. With this approach, false positives may be successfully removed, even if causes of the false positives may remain unclear, and certain discontinuities in the inferred salt body boundary may be filled in.

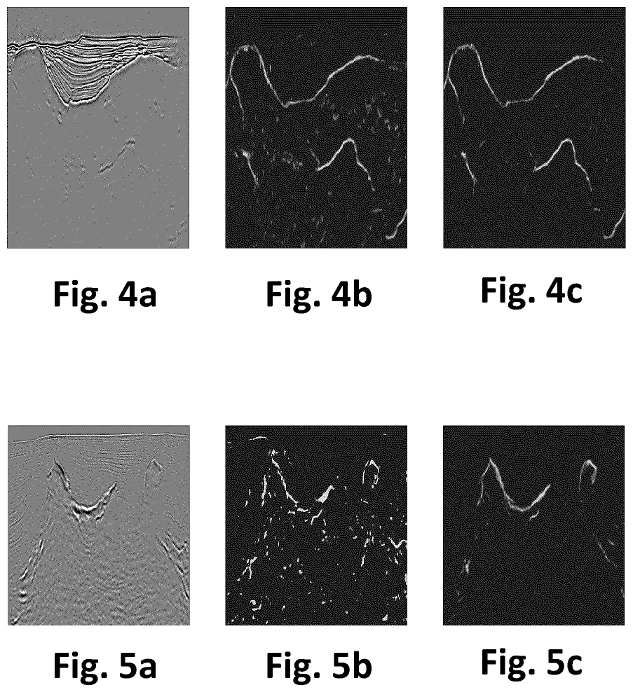

The refinement removal model is trained with a large dataset of pairs of noisy incomplete salt boundaries and their corresponding ground truths (human interpreted salt boundary). FIG. 3 shows an example of a training pair which was used to train the Refinement model. FIG. 3a shows a raw output from the trained first deep learning model and FIG. 3b shows corresponding ground truth labels as interpreted by a human. The human ground truths reflect continuous salt body boundary identifications. The refinement model inference step 30 ultimately generates a refined salt body boundary probability volume, based on the refined continuous salt body boundary identification. FIGS. 4 and 5 show examples of the refining on different inference data. Raw probability volumes generated by the salt body boundary inference 20 as shown in FIGS. 4b and 5b comprise misleading false positives which are adequately removed by the Refinement model inference 30 as shown in FIGS. 4c and 5c.

The refined salt body boundary probability volume as generated in by the Refinement model are then converted to a binary salt body boundary interpreted volume. This is the final salt body boundary inference 40. Based on this final inference, a salt body (salt bag) can be estimated taking the inferred salt body boundaries into consideration. An updated velocity model can then be generated in a step of updating the velocity model 50, by updating the initial velocity model (which was initially used to migrate the seismic data volume 10. Updating in essence takes into account a salt body estimation (salt bag) which matches with the binary salt body boundary interpreted volume.

The updated velocity model may then be used to remigrate the original post stack seismic data volume. This remigrated volume will be closer to reality as it takes into account a salt body estimate, or an improved salt body estimate compared to the initial migration.

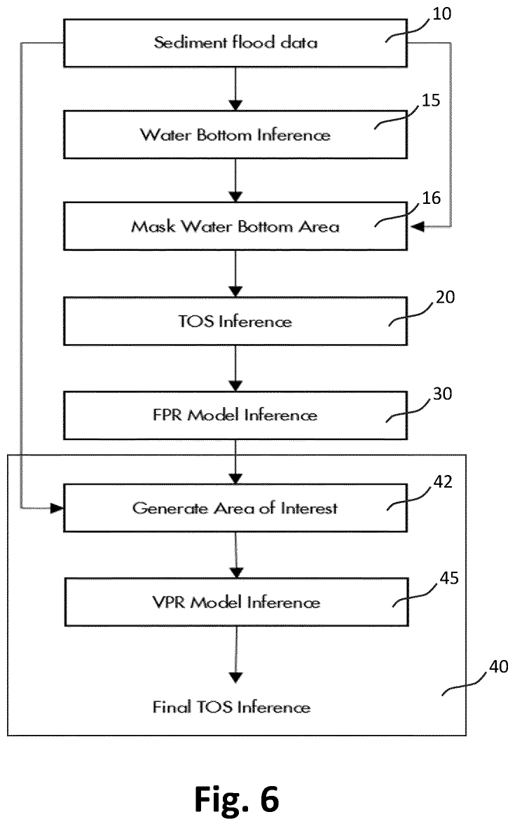

When the method is applied to delineate a TOS boundary, certain further machine learning models can be applied in sequence to achieve improvements that are specific to TOS. FIG. 6 shows an example of how the method described above may be embedded in a computer-implemented automated workflow specifically adapted for TOS identification. In this example, the initial migrated seismic data volume is referred to as sediment flood data 10 to emphasize that the initial velocity model only comprised of sediment velocities and no salt body velocities.

For example, in practice it has been found that water bottom (or sea floor) reflections often features as one of the sources of false positives, especially in the case of shallow salt geometries where the top of the salt comes in proximity and/or in contact with water bottom. In such cases, the deep learning model which is trained to delineate TOS boundary (i.e. sediment to salt interface) may easily get confused with the presence of high seismic reflection amplitudes at the water bottom and may not easily be able to distinguish these amplitudes from TOS amplitudes.

To address this challenge, the workflow may comprise water bottom inference 15 by means of another deep learning network, to detect and delineate water bottom from the sediment flood data (i.e. water to sediment boundary extraction), and then to a step of masking the water bottom area 16. This takes place prior to determining of the probability of salt body boundaries in the salt body boundary interference 20. The migrated seismic data volume (i.e. the sediment flood data volume) is input to a trained water bottom deep learning model. Signals associated with water-sediment boundary reflections in are delineated, and replaced with a constant value. This effectively generates a masked migrated seismic data volume, which can then be subjected to the trained first deep learning model of the salt body boundary interference 20, which in this case is effectively a TOS interference. The trained first deep learning model then may ignore the presence of water bottom area.

The TOS inference 20 and FPR model inference 30 may be done in accordance with the salt body boundary inference 20 and refinement model inference 30 as described above with reference to FIG. 1. The resulting salt body boundary as found is generally thicker (due the choice of training strategy) and its precise placement salt boundary aligned with seismic reflection peak is therefore another challenge. The final salt body boundary inference 40 may be therefore further refined, by an additional trained post processing deep learning models. A learning-based approach has thus been developed to snap the salt boundary to the nearest seismic reflection interface which is explained in the next step.

Illustrated is a trained vertical position refinement (VPR) deep learning model for a VPR model inference 45 which may be applied specifically to certain areas of interest (AOI) generated in step 42. The generation of area of interest step involves extracting a region around TOS inference from the FPR model inference 30, to achieve that the subsequent VPR deep learning model would only search for seismic reflection peaks in the neighborhood. The AOI generation is automatically applied. The VPR model inference 45 involves application of the trained VPR deep learning model on the AOI generated in step 42 and automatically snaps the salt body boundary at the reflection peak in the seismic data.

All steps and machine learning models may suitably be integrated under one common user interface and automatically executable in the computer system so that manual execution of subsequent models is not necessary. All sequential deep learning models are applied to the data by the computer system without human intervention.

The person skilled in the art will understand that the present invention can be carried out in many various ways without departing from the scope of the appended claims.

We claim:

1. A computer-implemented method of updating a velocity model of seismic waves in an Earth formation, comprising:
a) providing a migrated seismic data volume obtained by at least migrating a post stack seismic data volume using an initial velocity model;
b) determining a probability, for each point in the migrated seismic data volume, of including a signal corresponding to a reflection from a salt body boundary, comprising applying a trained first deep learning model to make said determination;
c) generating a first body boundary probability volume based on the probabilities as determined by the first deep learning model,
d) refining the probabilities in each point of the first salt body boundary probability volume by applying a trained refinement deep learning model, which selectively replaces probabilities with replacement probabilities of higher or lower values, to thereby generate a refined more continuous salt body boundary identification;
e) generating a refined salt body boundary probability volume based on the refined continuous salt body boundary identification;
f) converting the refined salt body boundary probability volume to a binary salt body boundary interpreted volume; and
g) generating an updated velocity model by updating the initial velocity model using a salt body estimation which matches with the binary salt body boundary interpreted volume.

2. The method of claim 1, further comprising migrating the post stack seismic data volume using the updated velocity model.

3. The method of claim 1, wherein the first deep learning model comprises a first deep convolutional neural network and/or wherein the refinement deep learning model comprises a refinement deep convolutional neural network.

4. The method of claim 1, wherein prior to determining of the probability, delineating signals associated with water-sediment boundary reflections the migrated seismic data volume and replacing these delineated signals with a constant value resulting in a masked migrated seismic data volume, and subjecting the masked migrated seismic data volume to step b).

5. The method of claim 1, wherein the trained first deep learning model has been trained using labeled 2D tiles in both in-line and cross-line directions, wherein the labeled 2D tiles comprise ground truth positive labels at salt body boundaries as determined by human interpretation.

6. The method of claim 1, wherein the trained refinement deep learning model has been trained using a training set of pairs of first salt body boundary probability volumes as interpreted by the trained first deep learning model and corresponding ground truths salt body boundaries as determined by human interpretation.

7. The method of claim 5, wherein the ground truth positive labels are applied to a predetermined number of surrounding pixels in said 2D tiles around the pixels that are human-interpreted to correspond to a salt body boundary.

8. The method of claim 1, wherein step f) comprises defining an area of interest comprising areas in the refined salt body boundary probability volume which include an inferred salt body boundary as indicated by relatively high probabilities of salt body boundary, and applying a trained vertical position refinement deep learning model on the area of interest to confine the inferred salt body boundary to nearest seismic peaks.

9. The method of claim 1, wherein the steps b) to f) are executed by a computer system without human intervention.

10. A computer system comprising:
at least one processor;
a memory system comprising non-transitory computer-readable non-transient memory on which are stored computer-readable instructions that, when executed by said at least one processor, cause the computer system to:
a) access a migrated seismic data volume obtained by at least migrating a post stack seismic data volume using an initial velocity model;
b) determine a probability, for each point in the migrated seismic data volume, of including a signal corresponding to a re lection from a salt body boundary, comprising applying a trained first deep learning model to make said determination;
c) generate a first salt body boundary probability volume based on the probabilities as determined by the first deep learning model,
d) refine the probabilities in each point of the first salt body boundary probability volume by applying a trained refinement deep learning model, which selectively replaces probabilities with replacement probabilities of higher or lower values, to thereby generate a refined continuous salt body boundary identification;
e) generate a refined salt body boundary probability volume based on the refined continuous salt body boundary identification;
f) convert the refined salt body boundary probability volume to a binary salt body boundary interpreted volume; and
g) generate an updated velocity model by updating the initial velocity model using a salt body estimation which matches the binary salt body boundary interpreted volume.
